(19) United States
(12) Patent Application Publication
(10) Pub. No.: US 2024/0255307 A1
(43) Pub. Date: Aug. 1, 2024

(54) INTERSECTION DETECTION FOR MAPPING IN AUTONOMOUS SYSTEMS AND APPLICATIONS

(71) Applicant: NVIDIA Corporation, Santa Clara, CA (US)

(72) Inventor: Yixuan Lin, San Jose, CA (US)

(21) Appl. No.: 18/159,884

(22) Filed: Jan. 26, 2023

(51) Int. Cl. G01C 21/00; G06T 7/70; G06V 20/56

(52) U.S. Cl. CPC G01C 21/3848; G01C 21/3815; G06T 7/70; G06V 20/588; G06T 2207/30256

(57) ABSTRACT

In various examples, intersections may be identified using sensor data for mapping in autonomous or semi-autonomous systems and applications. Systems and methods are disclosed that receive sensor data, such as image data, generated using one or more sensor of one or more vehicles navigating within an environment. The systems and methods may then use the sensor data to determine the locations and/or layouts of intersections within the environment and update a map to indicate the locations and/or layouts. For instance, the sensor data may be analyzed to detect the locations of the intersections, such as the locations of the boundaries of the intersections for which the vehicles navigated through. The map may then be updated to indicate the locations of the intersections by indicating the locations of the boundaries within the map, such as by using bounding shapes that are generated based on the locations of the boundaries.

### BACKGROUND

Autonomous driving systems and semi-autonomous driving systems (such as advanced driver assistance systems (ADAS)) may leverage sensors, such as image sensors, LiDAR sensors, RADAR sensors, and/or the like, to perform various tasks—such as lane keeping, lane changing, lane assignment, camera calibration, turning, path planning, and/or localization. For example, for autonomous and ADAS systems to operate independently and efficiently, an understanding of the surrounding environment of the vehicle must be achieved. This understanding may include information as to locations of objects, obstacles, lanes, intersections, and/or the like, and this information may be used by a vehicle when making path planning or control decisions—such as what path or trajectory to follow.

As an example, information regarding locations and layouts of intersections in an environment of an autonomous or semi-autonomous machine is important when making path planning, obstacle avoidance, and/or control decisions—such as where to stop, what path to use to safely traverse an intersection, where other vehicles or pedestrians may be located, and/or the like. This is particularly important when the vehicle is operating in urban and/or semi-urban driving environments, where intersection understanding becomes crucial for path planning due to the increased number of variables relative to a highway driving environment. For example, where a vehicle is to perform a left turn through an intersection in a bi-directional, multi-lane driving environment, determining locations of and directionality with respect to other lanes, as well as determining locations of crosswalks or bike paths, become critical to safe and effective autonomous and/or semi-autonomous driving.

In some examples, the vehicle may use a map of an environment for which the vehicle is navigating to identify locations and/or layouts of intersections. For instance, along with indications of lane locations, road boundary locations, and/or the like, a map (such as an HD map) may include indications (e.g., labels, bounding shapes, etc.) of the locations and/or layouts of the intersections within the environment. In order to generate such a map, conventional systems may use a specialized perception model to process map data, such as a bird-eye-view representation of a map, in order to detect the locations of the intersections within the map for labeling. However, training such a specialized perception model may require a large number of maps (e.g., training data), and the amount of labeling that is required—especially for a map that corresponds to a state, country, etc.—may be computationally expensive. Along with this, validation of label accuracy may be a burdensome task. Additionally or alternatively, in some approaches, human labelers may review map information and generate labels for intersections identified in the data. However, requiring human labelers to review and label intersections in maps may require countless hours of human effort, which may be costly and burdensome.

### SUMMARY

Embodiments of the present disclosure relate to using sensor data to identify intersections—such as for mapping—in autonomous or semi-autonomous systems and applications. Systems and methods are disclosed that receive sensor data, such as image data, generated using one or more sensors of one or more vehicles navigating within an environment. The systems and methods may then use the sensor data to determine the locations and/or layouts of intersections within the environment, and this information may be used—as an example non-limiting embodiment—to update a map that stores locations and/or layouts of intersections. These determinations may be made in real-time, during post-processing, and/or at any other time. Once the map is updated with intersection information, vehicles relying on the map for navigation may be localized to the map to determine a relative location of the vehicle with respect to intersections. Additionally, the sensor data may be analyzed to detect information about the intersections, such as locations and/or classification for boundaries, wait conditions (e.g., signs, traffic lights, crosswalks, lane markers/symbols, etc.), and/or other features of the intersections. The map may then be updated using bounding shapes that indicate the locations of the boundaries of the intersections, and/or may be updated to include other location or classification information associated with the intersection.

In contrast to conventional systems, such as those described above, the current systems are able to determine the locations and/or layouts of the intersections by processing sensor data generated using one or more sensors of one or more vehicles that are already navigating through the intersections—such as by crowd sourcing data from consumer vehicles, or by employing data collection vehicles. Additionally, the sensor data may be processed using systems, such as perception systems, that the vehicles already use for object detection, classification, and/or the like. This is in contrast to the conventional systems, such as those described above, which may require training a special perception model to detect intersections in bird-eye-view maps. As such, the perception data may be leveraged to aid in the labeling of intersections (and associated information) in map data.

### BRIEF DESCRIPTION OF THE DRAWINGS

The present systems and methods for using sensor data to identify, locate, and/or classify intersections for mapping in autonomous or semi-autonomous systems and applications are described in detail below with reference to the attached drawing figures, wherein:

FIG. 1 illustrates an example data flow diagram for a process of using sensor data to update a map to indicate a location of an intersection within an environment, in accordance with some embodiments of the present disclosure;

FIGS. 2A-2C illustrate examples of determining locations associated with an intersection depicted by images, in accordance with some embodiments of the present disclosure;

FIG. 3 illustrates an example of vehicles generating sensor data representing an intersection while navigating through an environment, in accordance with some embodiments of the present disclosure;

FIG. 4 illustrates an example of projecting locations associated with an intersection to a map, in accordance with some embodiments of the present disclosure;

FIG. 5 illustrates an example of filtering locations associated with an intersection that were projected to a map, in accordance with some embodiments of the present disclosure;

FIGS. 6A-6B illustrate an example of determining a location and/or a layout of an intersection using locations associated with boundaries of the intersection, in accordance with some embodiments of the present disclosure;

FIG. 7 is a flow diagram showing a method for using sensor data to identify an intersection, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

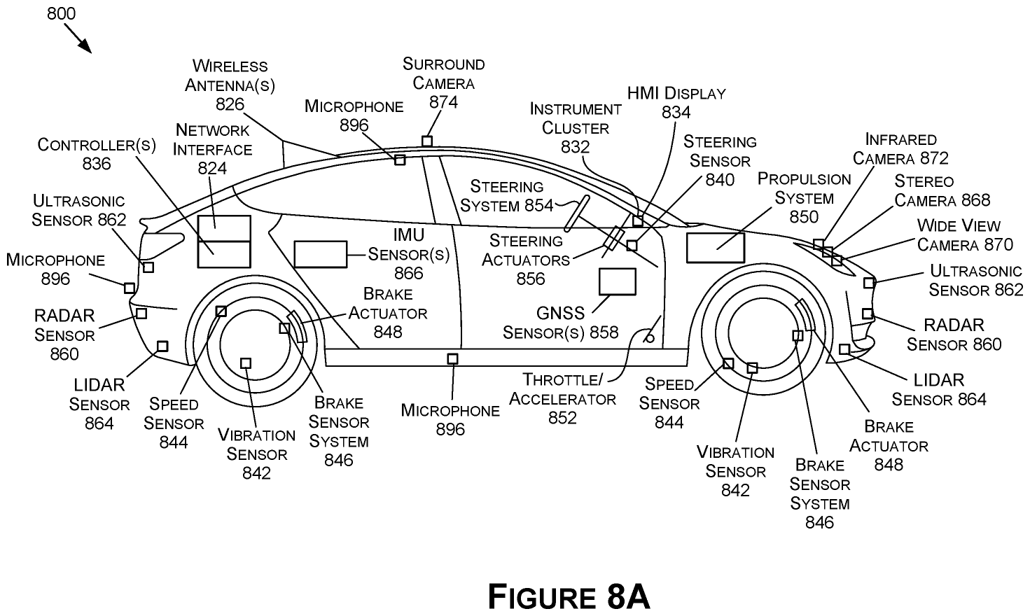

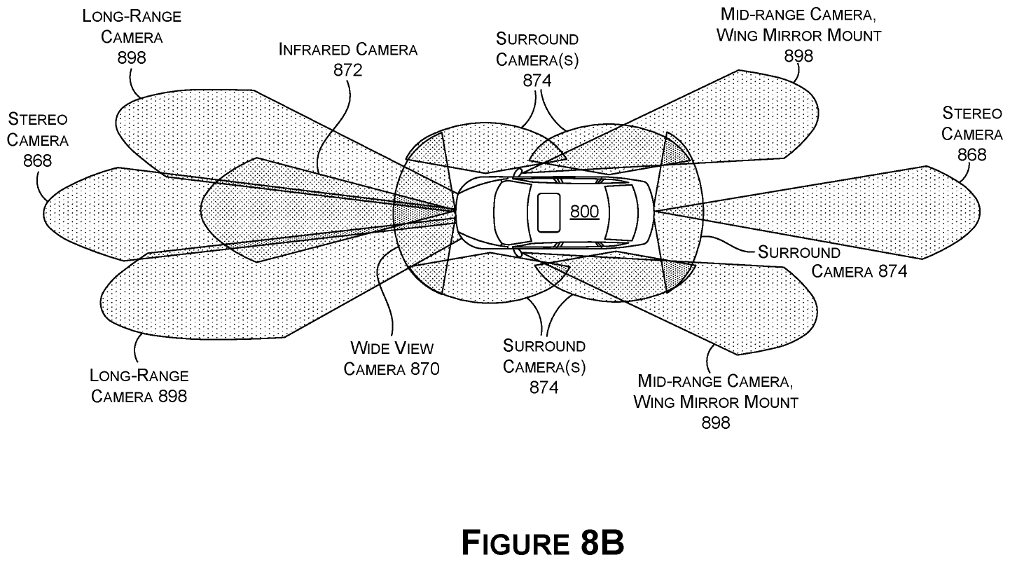

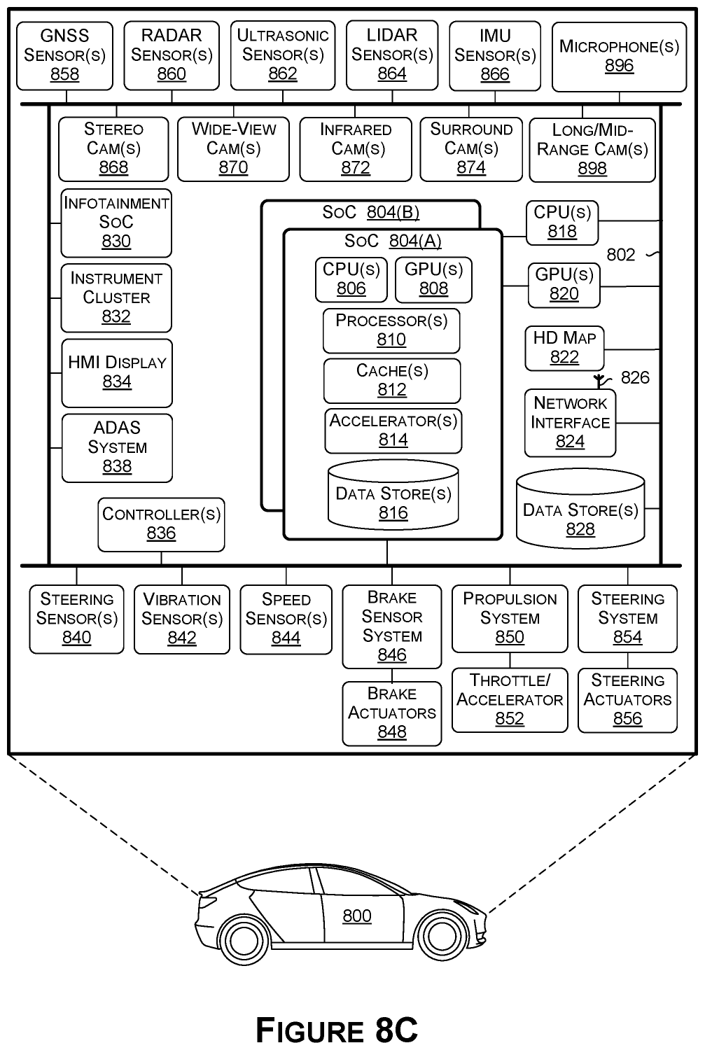

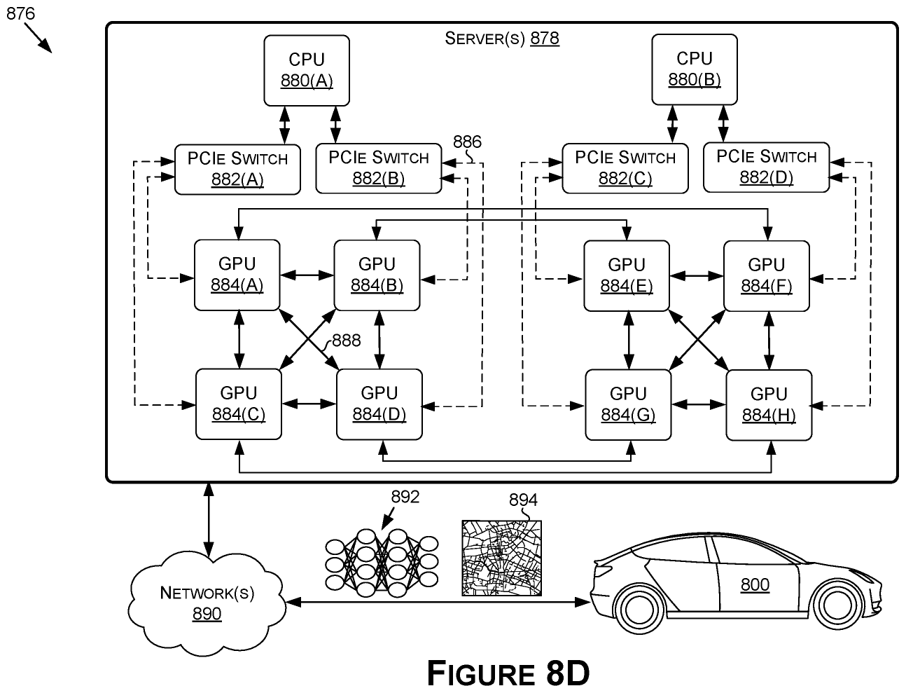

Systems and methods are disclosed related to using sensor data to identify intersections for mapping in autonomous systems and applications. Although the present disclosure may be described with respect to an example autonomous or semi-autonomous machine or vehicle 800 (alternatively referred to herein as “vehicle 800” or “ego-machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to intersection detection for autonomous or semi-autonomous systems or applications, this is not intended to be limiting, and the systems and methods described herein may be used in augmented reality, virtual reality, mixed reality, robotics, security and surveillance, autonomous or semi-autonomous machine applications, and/or any other technology spaces where intersection (or any other discrete or delineated area) detection may be used.

For instance, and for an intersection within an environment, vehicles navigating through the environment may generate sensor data representing or corresponding to the intersection. For example, and for a vehicle, the vehicle may generate image data representing images depicting the intersection as the vehicle is approaching the intersection, navigating through the intersection, and/or exiting the intersection. This way, the images generated using the vehicles at least partially depict different views of the intersection, such as one or more of the boundaries of the intersection. As described herein, a boundary of an intersection may include, but is not limited to, an entrance of the intersection, an exit of the intersection, a side of the intersection, an edge of the intersection, and/or any other component or feature that indicates the location and/or layout of the intersection. In some embodiments, a buffer may be added to detected features of the intersection to determine the boundary line(s). For example, where an entry to an intersection is a crosswalk, a one meter, two meter, five meter, etc. buffer may be added from the entry line of the crosswalk to account for any error or other features that may be considered as part of the intersection. In such an example, the boundary line may be a line extending substantially in parallel with the crosswalk entry line, but may be offset by some buffer or margin. In some examples, an intersection may include any number of entries. For a first example, an intersection that is associated with a four-way stop may include four entries. For a second example, an intersection that is associated with a three-way stop may include three entries.

One or more system (e.g., a system(s) on a vehicle or other machine, a system(s) remote from the vehicles or other machine, etc.) may receive the sensor data generated using one or more sensors of the vehicles, and may use the sensor data to determine the location, layout, features, classifications, and/or other information about the intersection. For instance, and again for a vehicle that navigates through one of the boundaries of the intersection while generating image data (and/or other sensor data from one or more other sensor modalities), the system(s) may initially localize the vehicle with respect to the intersection. In some examples, the system(s) may localize the vehicle using data (e.g., location data) received from the vehicle and/or map data representing a map (e.g., an HD map, a GNSS/GPS map, etc.) of the environment for which the intersection is located. The system(s) may also process the image data (and/or other sensor data), such as by using a perception system, to determine a location(s), classification, feature locations, etc. of the intersection as depicted by an image(s) (or other sensor data representation, such as a point cloud, occupancy map, projection image, etc.) represented by the image data (and/or other sensor data). For instance, and for an image as an example, the system(s) may determine a bounding shape (e.g., a bounding box) associated with the image that indicates the location of (e.g., one or more features of) the intersection as depicted by the image. The system(s) may then use this information in addition to the localization with respect to, e.g., a map, to determine or identify the location(s) of the intersection (e.g., the boundary shape(s)) as depicted by the image(s)—e.g., to determine a location(s) of a boundary(ies) associated with the intersection.

The system(s) may then use the location(s) of the boundary(ies) from the image(s), as well as the localization of the vehicle, to determine at least a final location of the boundary(ies) associated with the intersection. For instance, the system(s) may project the location(s) of the boundary(ies) as determined using the image(s) to one or more maps corresponding to the environment in which the intersection is located. In some examples, such as when the vehicle generates multiple images depicting the boundary of the intersection and/or more than one vehicle generates images depicting the boundary of the intersection, the system(s) may project one or more of (e.g., each) of the locations determined using the images to the map. The system(s) may then use the projected location(s) on the map to determine the final location of the boundary associated with the intersection on the map.

For example, the system(s) may perform clustering in order to group one or more of the projected location(s) together, such as projected locations that are within a threshold distance to one another. The threshold distance may include, but is not limited to, 0.2 meters, 0.5 meters, 1 meter, 2 meters, and/or any other distance. The system(s) may also filter out one or more of the projected location(s) that are not included within the clustered locations, such as a projected location(s) that is outside of the threshold distance. Using the cluster location(s), the system(s) may then determine the final location for the boundary(ies) associated with the intersection. For a first example, the system(s) may determine that the final location of the boundary includes the average of the clustered location(s). For a second example, the system(s) may determine that the final location for the boundary(ies) includes one of the clustered location(s), such as the projected location that is the farthest from the intersection, the projected location that is the closest to the intersection, the middle-projected location, and/or the like.

The system(s) may then perform similar processes to determine the final locations of the other boundaries associated with the intersection. Additionally, the system(s) may use the final locations for the boundaries associated with the intersection to determine the overall location and/or layout of the intersection within the environment. For example, the system(s) may determine the overall location and/or layout of the intersection by connecting each of the final locations of the boundaries together, such as by creating a bounding shape (e.g., a box, a polygon, etc.) that represents the intersection.

While these examples describe performing these processes to determine the location and/or layout of a single intersection, in some examples, similar processes may be performed to determine the locations and/or layouts of multiple intersections within the environment. Additionally, while these examples describe performing these processes to determine the locations and/or layouts of intersections, in some examples, similar processes may be performed to determine the locations and/or layouts of other features or environmental spaces where boundary identification may be helpful or desired. For instance, the system(s) may perform similar processes to determine the locations and/or layouts of school zones, crosswalks, construction zones, and/or any other feature or space to be delineated associated with an environment.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, a mapping system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

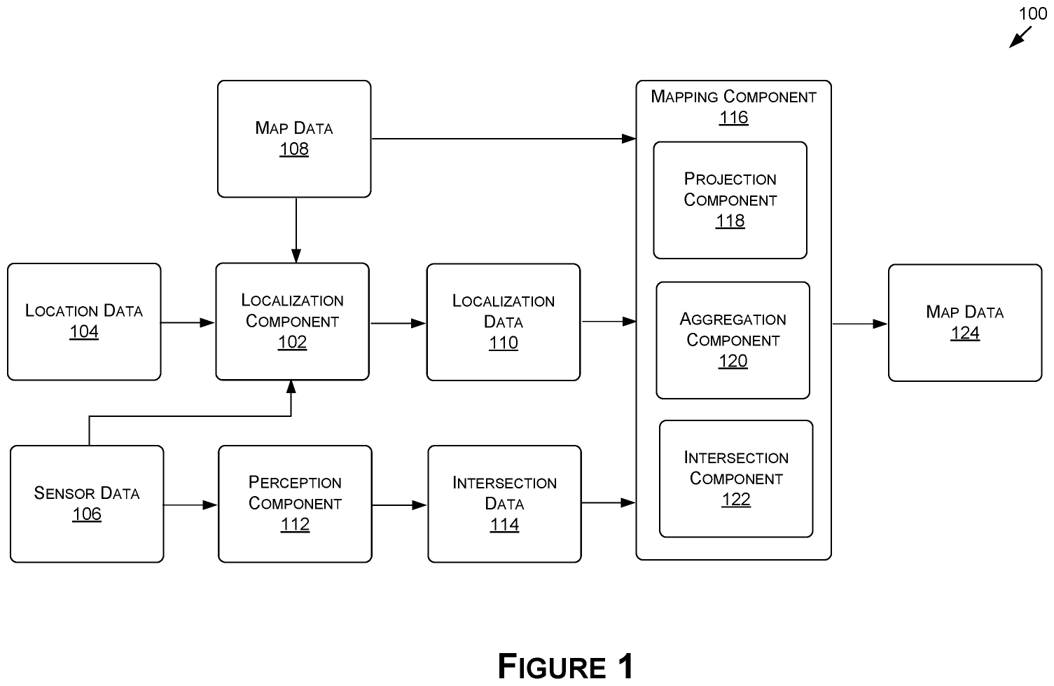

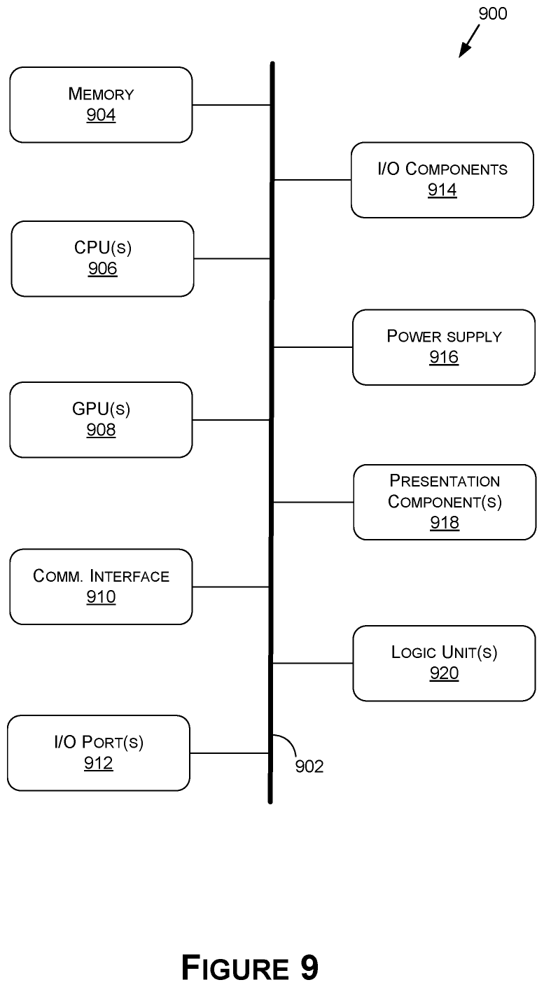

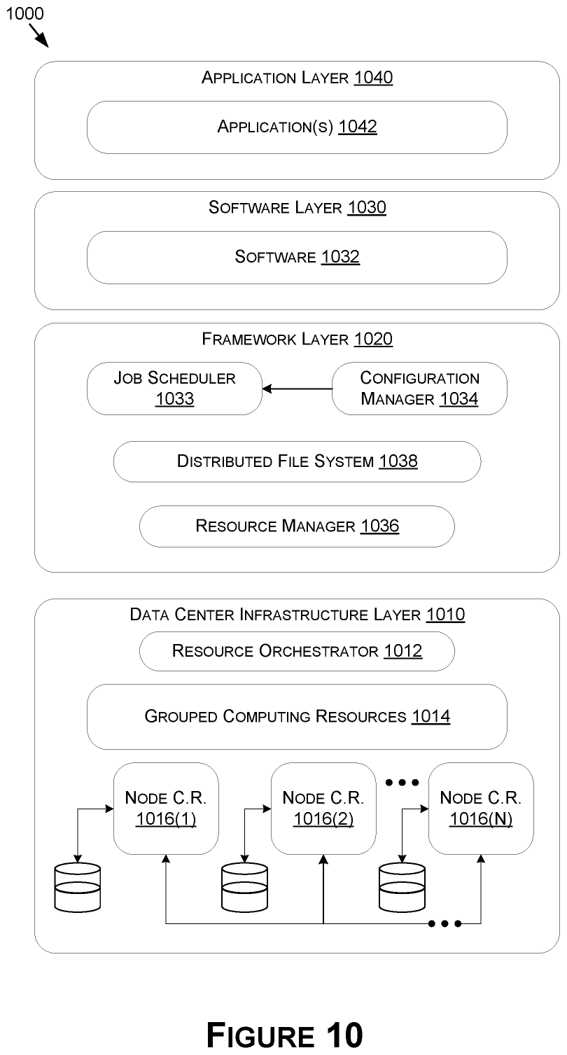

With reference to FIG. 1, FIG. 1 illustrates an example data flow diagram for a process 100 of using sensor data to identify an intersection(s) and update a map to indicate a location (and/or other information corresponding to the intersection) of an intersection within an environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

The process 100 may include a localization component 102 receiving location data 104 and/or sensor data 106 generated using one or more sensors of one or more vehicles. For instance, a vehicle may generate the location data 104 and/or the sensor data 106 while navigating through an environment. The location data 104 may include, but is not limited to, Global Positioning System (GPS) data, Global Navigation Satellite System (GNSS) data, Inertial Measurement Unit (IMU) data, triangulation data, and/or any other type of data that may be used to localize the vehicle within the environment. Additionally, the sensor data 106 may include, but is not limited to, image data generated by an image sensor(s), RADAR data generated by a RADAR sensor, LiDAR data generated by a LiDAR sensor, and/or any other by of sensor data generated by any other type of sensor. In some embodiments, the sensor data 106 may additionally or alternatively be used to localize the vehicle—e.g., with respect to a map.

To localize the vehicle, the localization component 102 may receive the location data 104 generated by the vehicle along with map data 108 representing a map of the environment for which the vehicle is navigating. In some examples, the map may include a precision to a centimeter-level or finer, such that the localization component 102 may rely on the map for precise instructions, planning, and localization. In some examples, the map may represent lanes, road boundaries, road shape, intersections, elevation, slope, and/or contour, heading information, wait conditions, static object locations, and/or other information associated with the environment. In some examples, the map may represent a road topological graph associated with the environment.

As such, the localization component 102 may use the location data 104 and the map data 108 to localize (e.g., for location and/or orientation) the vehicle with respect to the map. For example, the location data 104 may be used to determine an approximate location of the vehicle on the map. This information may be used to determine a region of the map that should be analyzed to accurately localize the vehicle within the map. In some examples, the localization component 102 may then use the sensor data 106 generated by the vehicle's sensors—e.g., cameras, RADAR sensors, LIDAR sensor, and/or the like—to identify features and/or objects within the environment that have known and accurate locations within region of the map. Once the vehicle is localized within the map a first time, the locations and/or orientations of the vehicle over time may be tracked using this same localization technique—e.g., using vision-based sensors to identify objects and/or features having known locations in the map—and/or may be tracked using the location data 104 (e.g., the IMU data, visual odometry data, etc.). For example, once the vehicle is localized initially, the localization component 102 may accurately track a change in location and/or orientation (e.g., pose) of the vehicle over time.

In some examples, the localization component 102 may apply the sensor data 106 and/or the information from the map to a coordinate transformer to transform the sensor data 106 and/or the map to a coordinate system of the vehicle and/or to transform the map data from the map to a coordinate space of the sensor data 106 (e.g., to transform the 3D world-space map data to 2D image- or sensor-space). In order for the coordinate transformer to perform the transformations or shifts described herein, intrinsic (e.g., optical center, focal length, etc.) and/or extrinsic (e.g., location of sensor on the vehicle, rotation, translation, etc.) parameters of the sensors may be used to determine a correlation between 2D pixel locations (or other image- or sensor-space locations) and 2D or 3D world-space locations on the map.

For example, the localization component 102 may orient the map with respect to the vehicle and/or with respect to a field of view of a sensor that captured the instance of the sensor data 106. In some embodiments, the localization component 102 may shift the perspective of the map data 108 with respect to a location and/or orientation of the vehicle and/or a sensor thereof. In some examples, in addition to or alternatively from shifting the perspective or coordinate system with respect to the vehicle and/or a sensor thereof, the localization component 102 may shift the perspective to a same field of view for each type of data. For example, where the map may generate data from a top-down perspective of the environment, the sensors that generate the sensor data 106 may do so from different perspectives—such as front-facing, side-facing, angled downward, angled upward, etc.

Additionally, or alternatively, in some examples, the localization component 102 may apply the sensor data 106 and/or the information from the map to a coordinate transformer to transform the sensor data 106 to a coordinate system of the map (e.g., to transform the 2D image- or sensor-space to the 3D world-space map data). In order for the coordinate transformer to perform the transformations or shifts described herein, intrinsic (e.g., optical center, focal length, etc.) and/or extrinsic (e.g., location of sensor on the vehicle, rotation, translation, etc.) parameters of the sensors may be used to determine a correlation between 2D pixel locations (or other image- or sensor-space locations) and 2D or 3D world-space locations on the map. For example, the localization component 102 may orient a field of view of a sensor that captured the instance of the sensor data 106 with respect to the map. In some examples, the localization component 102 may shift a location and/or orientation of the vehicle and/or a sensor thereof with respect to the perspective of the map data 108.

The localization component 102 may then output localization data 110 representing locations of vehicles with respect to the map, transformations of the coordinates system of the map with respect to the coordinate systems of the vehicles and/or the sensors of the vehicles, and/or transformations of the coordinate systems of the vehicles and/or the sensors of the vehicles with respect to the coordinate system of the map. In some examples, the localization data 110 may further include timestamps, such as timestamps indicating times that the vehicles were at the locations associated with the map.

The process 100 may include a perception component 112 that processes the sensor data 106 generated using the one or more sensors of the one or more vehicles in order to determine the locations of intersections represented by the sensor data 106. For instance, the perception component 112 may include functionality to perform object detection, segmentation, classification, and/or other perception tasks. For example, the perception component 112 may detect lanes and boundaries on driving surfaces, lanes and boundaries of intersections, drivable free-space, poles or signs, traffic lights, objects in the environment (e.g., vehicles, pedestrians, animals, inanimate objects, etc.), wait conditions and intersections, and/or the like. In additional or alternative examples, the perception component 112 may determine states of detected objects and/or the environment in which the object is positioned. As described herein, the states associated with an object may include, but are not limited to, a location (e.g., an x-position (global and/or local position), a y-position (global and/or local position), a z-position (global and/or local position)), an orientation (e.g., a roll, pitch, yaw), an object classification (e.g., a type of object), a velocity, an acceleration, an extent (size), and/or any other information associated with the object.

In those examples in which the perception component 112 performs detection, the perception component 112 may generate data that indicates detections of objects (and/or features) detected in an image. Such detections may comprise 2D and/or 3D bounding shapes and/or masks of detected objects. Additionally, in some examples, the data may indicate one or more probabilities associated with an object, such as a probability associated with the location of the object, a probability associated with the classification of the object, a probability associated with the velocity of the object, and/or the like. In some examples, the perception component 112 may use a machine learning approach (e.g., scale-invariant feature transform (SIFT), histogram of oriented gradients (HOG), etc.) followed by a support vector machine (SVM) to classify objects depicted in images represented by the sensor data 106. Additionally, or alternatively, in some examples, the perception component 112 may use a deep learning approach based on, for example and without limitation, a convolutional neural network (CNN) to detect and/or classify objects depicted in images (or other sensor data representations) represented by the sensor data 106. While these are just a couple example approaches that may be used by the perception component 112, in other examples, the perception component 112 may use additional and/or alternative approaches to classify and/or detect objects depicted in the sensor data 106.

For instance, such as when the sensor data 106 includes image data generated using one or more image sensors, the perception component 112 may analyze the image data in order to detect an intersection depicted the images represented by the image data. In some examples, the perception component 112 may then generate intersection data 114 indicating the locations of the intersection in the images. For instance, the intersection data 114 may represent two-dimensional bounding shapes and/or masks that indicate the locations of the intersection (or features or components thereof) within the images. In some examples, the perception component 112 may further determine locations of the boundaries associated with the intersection. As described herein, in some examples, the perception component 112 may detect a boundary based using one or more of the edges of the bounding shape associated with the intersection, such as a bottom edge of the bounding shape, a top edge of the bounding shape, a right edge of the boundary shape, or a left edge of the bounding shape. In some embodiments, as described herein, a buffer or additional margin may be added to bounding shapes or added beyond a bounding shape. The perception component 112 may then generate the intersection data 114 to further indicate the locations of the boundary(ies) of the intersection.

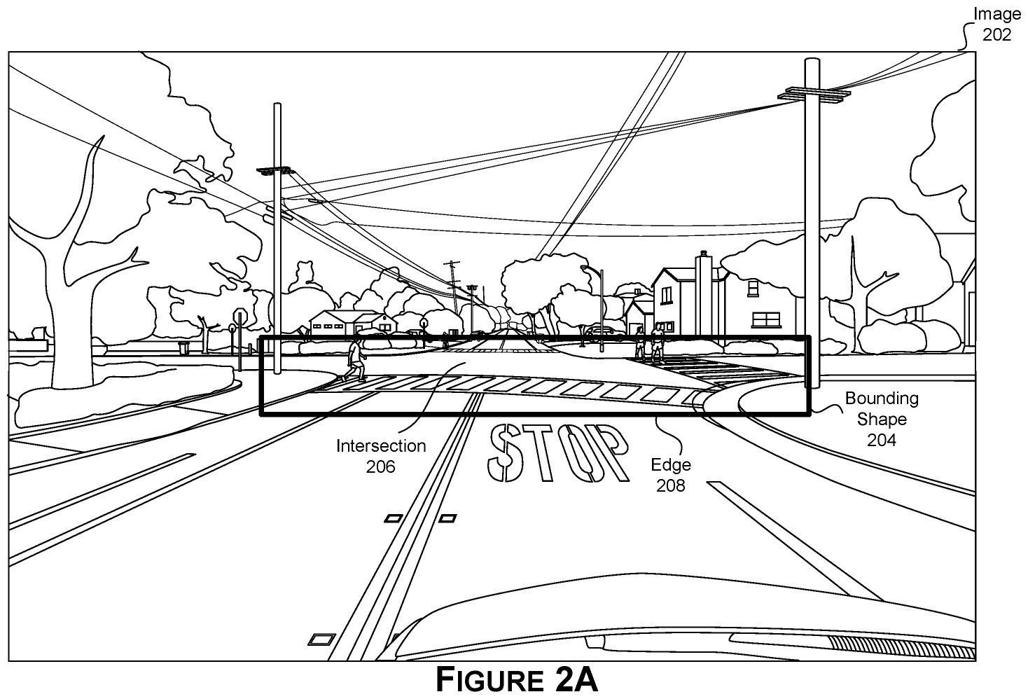

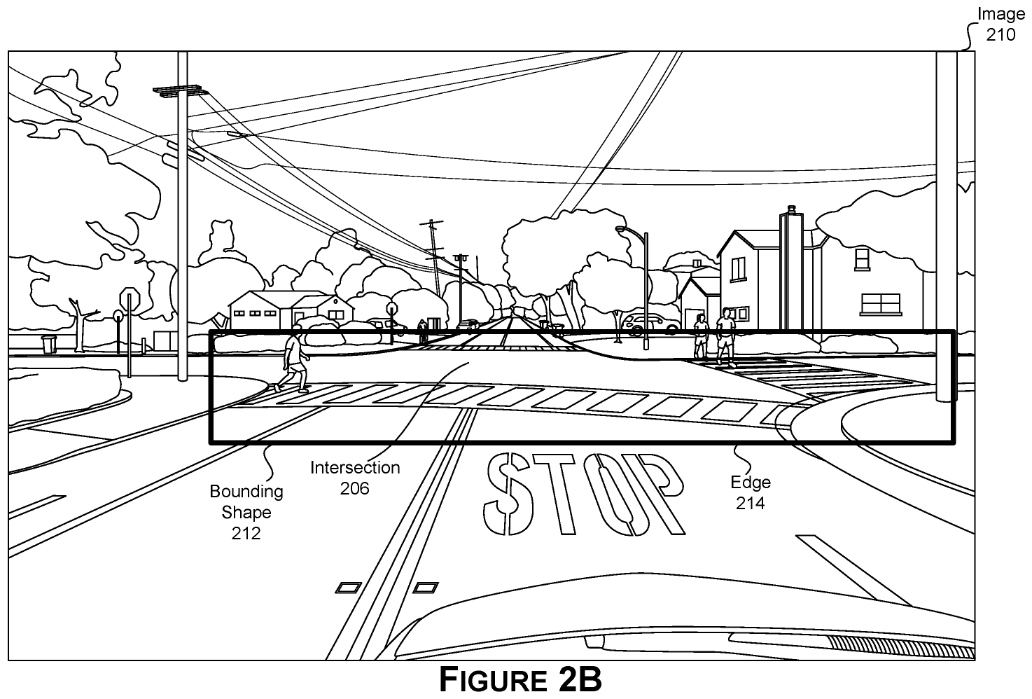

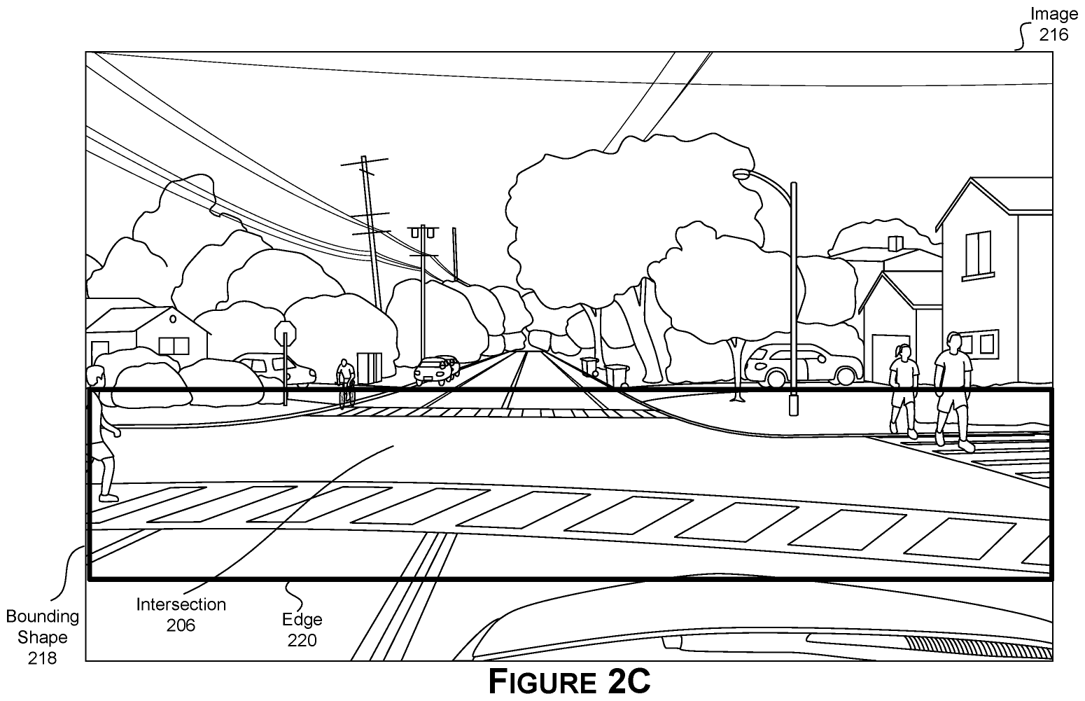

For instance, FIGS. 2A-2C illustrate examples of determining locations associated with an intersection depicted by images, in accordance with some embodiments of the present disclosure. As shown by the example of FIG. 2A, the perception component 112 may analyze an image 202, which may be represented by the sensor data 106, in order to determine a bounding shape 204 that indicates the location of an intersection 206 depicted by the image 202. In the example of FIG. 2A, the intersection 206 includes a four-way intersection with four boundaries and the bounding shape 204 includes an entirety of the intersection 206 including each of the boundaries. In some examples, the perception component 112 may then determine at least a location of one of the boundaries of the intersection 206, such as the boundary associated with the entrance for which the vehicle navigates to enter the intersection 206. For example, the perception component 112 may determine the location of the boundary as including an edge 208 of the bounding shape 204 that is associated with the boundary. However, in other examples, the perception component 112 may determine the location of boundary using one or more additional and/or alternative techniques.

Additionally, and shown by the example of FIG. 2B, the perception component 112 may analyze an image 210, which may be represented by the sensor data 106, in order to determine a bounding shape 212 that indicates the location of the intersection 206 depicted by the image 210. In the example of FIG. 2B, the bounding shape 212 again includes an entirety of the intersection 206 including each of the boundaries. In some examples, the perception component 112 may then determine at least a location of one of the boundaries of the intersection 206, such as the boundary associated with the entrance for which the vehicle navigates to enter the intersection 206. For example, the perception component 112 may determine the location of the boundary as including an edge 214 of the bounding shape 212 that is associated with the boundary. However, in other examples, the perception component 112 may determine the location of boundary using one or more additional and/or alternative techniques.

Furthermore, and shown by the example of FIG. 2C, the perception component 112 may analyze an image 216, which may be represented by the sensor data 106, in order to determine a bounding shape 218 that indicates the location of the intersection 206 depicted by the image 216. In the example of FIG. 2C, the bounding shape 218 includes a majority of the intersection 206 that is depicted by the image 216, including at least the boundary for which the vehicle will use to navigate through the intersection 206. In some examples, the perception component 112 may then determine at least a location of one of the boundaries of the intersection 206, such as the boundary associated with the entrance for which the vehicle navigates to enter the intersection 206. For example, the perception component 112 may determine the location of the boundary as including an edge 220 of the bounding shape 218 that is associated with the boundary. However, in other examples, the perception component 112 may determine the location of boundary using one or more additional and/or alternative techniques.

In the examples of FIGS. 2A-2C, a single vehicle may have generated the image data representing each of the images 202, 210, and 216 when the vehicle was approaching the intersection 206. However, in other examples, more than one vehicle may have generated image data representing the images 202, 210, and 216 when the vehicles were approaches the intersection.

Additionally, while the examples of FIGS. 2A-2C describe determining the location of the boundary associated with the entrance for which the vehicle used to navigate through the intersection 206, in other examples, the perception component 112 may additionally or alternatively determine one or more of the other boundaries. For instance, and using the example of FIG. 2A, the perception component 112 may determine a boundary using the left edge the bounding shape 204, a boundary using the top edge of the bounding shape, or a boundary using the right edge of the bounding shape. The perception component 112 may then perform similar processes to determine similar boundaries in one or more (e.g., each) of the other images.

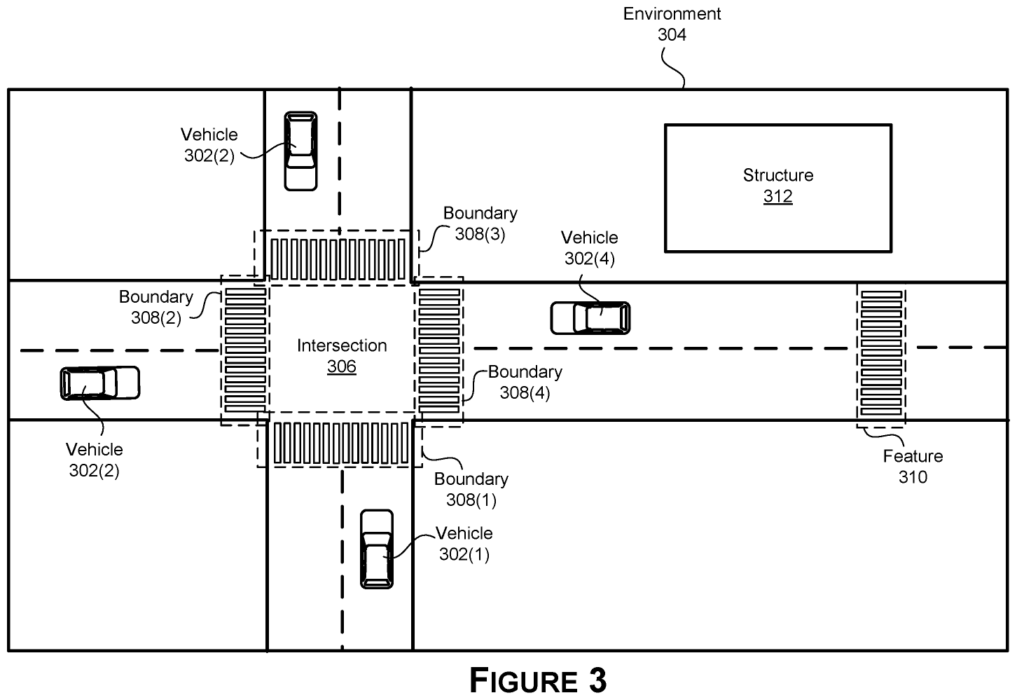

FIG. 3 illustrates an example of vehicles generating sensor data representing an intersection while navigating through an environment, in accordance with some embodiments of the present disclosure. As shown, vehicles 302(1)-(4) (also referred to singularly as “vehicle 302” or in plural as “vehicles 302”) may be navigating around an environment 304 that includes an intersection 306 (which may represent, and/or include, the intersection 206). For instance, the first vehicle 302(1) may be navigating towards a first boundary 308(1) of the intersection 306, the second vehicle 302(2) may be navigating towards a second boundary 308(2) of the intersection 306, the third vehicle 302(3) may be navigating towards a third boundary 308(3) of the intersection 306, and the fourth vehicle 302(4) may be navigating towards a fourth boundary 308(4) of the intersection 306.

As such, the first vehicle 302(1) may generate sensor data representing the intersection 306 from a perspective of the first boundary 308(1), the second vehicle 302(2) may generate sensor data representing the intersection 306 from a perspective of the second boundary 308(2), the third vehicle 302(3) may generate sensor data representing the intersection 306 from a perspective of the third boundary 308(3), and the fourth vehicle 302(4) may generate sensor data representing the intersection 306 from a perspective of the fourth boundary 308(4). The sensor data generated by each of the vehicles 302 may then be used to determine the locations of the boundaries 308(1)-(4) of the intersection 306.

For example, the perception component 112 may process the sensor data generated by the first vehicle 302(1) in order to determine first locations associated with the first boundary 308(1) (and/or locations associated with the other boundaries 308(2)-(4)) of the intersection 306, process the sensor data generated by the second vehicle 302(2) in order to determine second locations associated with the second boundary 308(2) (and/or locations associated with the other boundaries 308(1) and 208(3)-(4)) of the intersection 306, process the sensor data generated by the third vehicle 302(3) in order to generate third locations associated with the third boundary 308(3) (and/or locations associated with the other boundaries 308(1)-(2) and 308(4)) of the intersection, and process the sensor data generated by the fourth vehicle 302(4) in order to determine fourth locations associated with the fourth boundary 308(4) (and/or locations associated with the other boundaries 308(1)-(3)) of the intersection 306. The perception component 112 may then generate intersection data (e.g., the intersection data 114) representing the locations of the boundaries 308(1)-(4) of the intersection 306.

As further illustrated in the example of FIG. 3, the environment 304 may include a feature 310, such as a crosswalk to access a structure 312. As described further herein, similar processes as those described herein with respect to intersections may be used to determine the location and/or the layout of the feature 310.

Referring back to the example of FIG. 1, the process 100 may include a mapping component 116 that is configured to use the localization data 110 and/or the intersection data 114 in order to update the maps to indicate the locations and/or layouts of intersections. For instance, the mapping component 116 may include a projection component 118 that is configured to map the locations of the intersections, as represented by the intersection data 114, to a map. In some examples, to perform the mapping, the projection component 118 may use the localization data 110 to identify the intersection that is associated with the intersection data 114 (e.g., the intersection represented by the sensor data 106) and/or the boundaries of the intersection that are associated with the intersection data 114. The projection component 118 may then use the transformations from the coordinate systems (e.g., the 2D image- or sensor-space) associated with the vehicle and/or the sensor that generated the sensor data 106 to the coordinate system (e.g., the 3D world-space) of the map to perform the mapping.

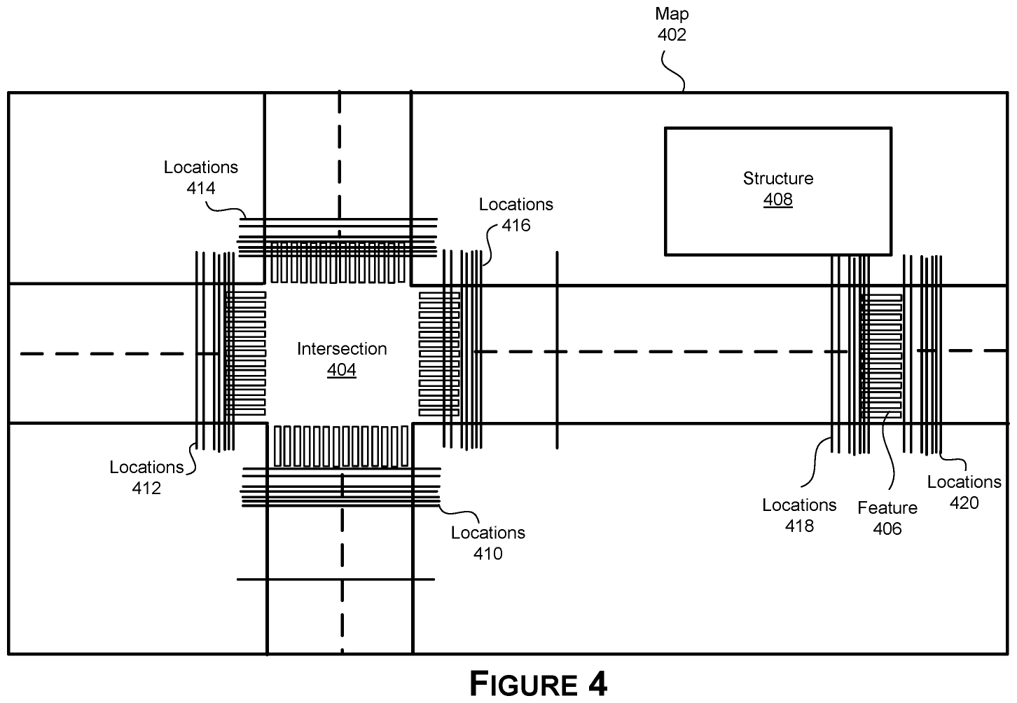

For instance, FIG. 4 illustrates an example of projecting locations associated with the intersection 306 to a map 402, in accordance with some embodiments of the present disclosure. For instance, the map 402 may represent at least the environment 304 that the vehicles 302 were navigating, where the map 402 includes at least a representation 404 of the intersection 306 (which may also be referred to as the “intersection 404”), a representation 406 of the feature 310 (which may also be referred to as the “feature 406”), a representation 408 of the structure 312 (which may also be referred to as the “structure 408”), and representations of the roads. The projection component 118 may then use the intersection data 114 and/or the localization data 110 to project the locations of the boundaries 308(1)-(4) of the intersection 306 to the map 402.

For example, and as described herein, the projection component 118 may use the intersection data generated by the perception component 112, along with localization data representing the locations of the first vehicle 302(1) when generating the sensor data, to map the first locations associated with the first boundary 308(1) (and/or map locations associated with the other boundaries 308(2)-(4)) to the map 402, which is represented by locations 410 (although only one is labeled for clarity reasons). Additionally, the projection component 118 may use the intersection data generated by the perception component 112, along with localization data representing the locations of the second vehicle 302(2) when generating the sensor data, to map the second locations associated with the second boundary 308(2) (and/or map locations associated with the other boundaries 308(1) and 308(3)-(4)) to the map 402, which is represented by locations 412 (although only one is labeled for clarity reasons). Furthermore, the projection component 118 may use the intersection data generated by the perception component 112, along with localization data representing the locations of the third vehicle 302(3) when generating the sensor data, to map the third locations associated with the third boundary 308(3) (and/or map locations associated with the other boundaries 308(1)-(2) and 308(4)) to the map 402, which is represented by locations 414 (although only one is labeled for clarity reasons). Moreover, the projection component 118 may use the intersection data generated by the perception component 112, along with localization data representing the locations of the fourth vehicle 302(4) when generating the sensor data, to map the fourth locations associated with the fourth boundary 308(4) (and/or map locations associated with the other boundaries 308(1)-(3)) to the map 402, which is represented by locations 416 (although only one is labeled for clarity reasons).

As further illustrated in the example of FIG. 4, the projection component 118 may use similar processes to project locations 418 (although only one is labeled for clarity reasons) associated with a first boundary of the feature 310 and project locations 420 (although only one is labeled for clarity reasons) associated with a second boundary of the feature 310.

Referring back to the example of FIG. 1, the mapping component 116 may include a aggregation component 120 that is configured to filter the locations projected on the map (e.g., the topological graph of the roads) using one or more techniques. For instance, in some examples, the aggregation component 120 may group one or more of the locations associated with an entrance using one or more criteria. For a first example, the aggregation component 120 may group one or more locations that are proximate to one another, such as within a threshold distance (e.g., 0.2 meters, 0.5 meters, 1 meter, 2 meters, etc.) to one another. For a second example, such as when there are multiple locations identified for an entrance, the aggregation component 120 may identify one of the locations (e.g., the middle location) and then group one or more locations that are within a threshold distance to the identified location. For a third example, the aggregation component 120 may use a threshold number of locations, such as one location, two locations, five locations, ten locations, and/or the like, when grouping the locations. While these are just a couple example techniques of how the aggregation component 120 may group locations, in other examples, the aggregation component 120 may use additional and/or alternative techniques to group locations.

Additionally to, or alternatively from grouping the locations, in some examples, the aggregation component 120 may filter the locations by removing one or more of the locations. For a first example, such as when the aggregation component 120 initially groups one or more of the locations, the aggregation component 120 may then remove any location that is outside of the group. For a second example, such as when the aggregation component initially identifies one of the locations (e.g., the middle location), the aggregation component 120 may then remove one or more locations that are outside of a threshold distance to the identified location. While these are just a couple example techniques of how the aggregation component 120 may filter locations, in other examples, the aggregation component 120 may use additional and/or alternative techniques to filter the locations.

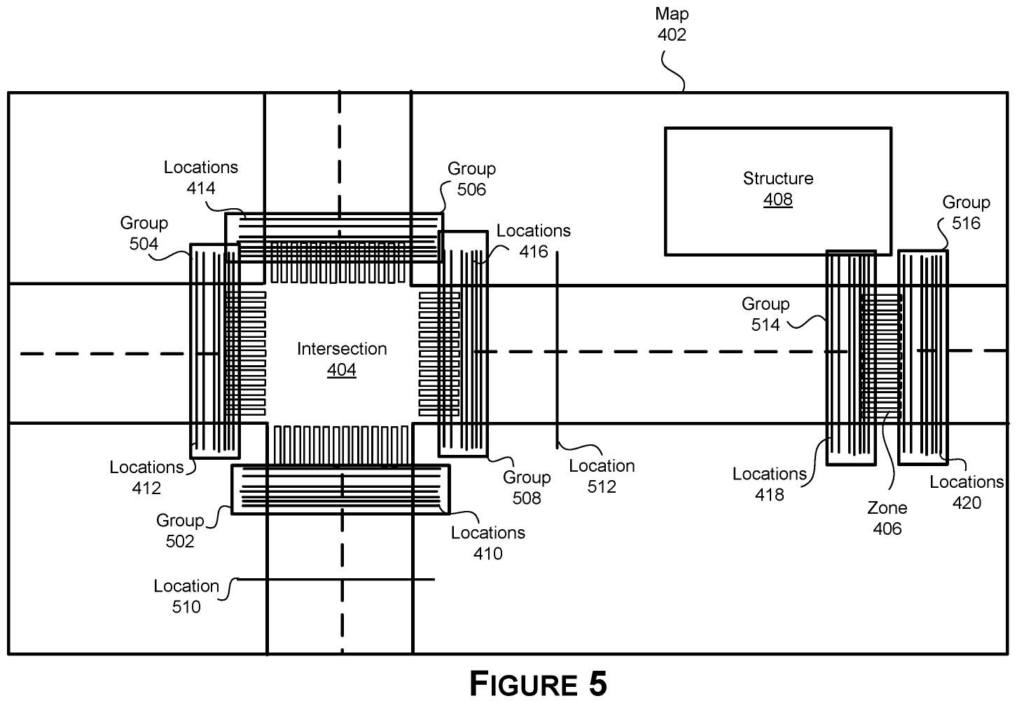

For instance, FIG. 5 illustrates an example of filtering the locations associated with the intersection 306 that were projected to the map 402, in accordance with some embodiments of the present disclosure. For instance, and in the example of FIG. 5, the aggregation component 120 may perform one or more of the processes described herein to generate a first group of locations 502 using at least a portion of the first locations 410 associated with the first boundary 308(1) of the intersection 306, generate a second group of locations 504 using at least portion of the second locations 412 associated with the second boundary 308(2) of the intersection 306, generate a third group of locations 506 using at least a portion of the third locations 414 associated with the third boundary 308(3) of the intersection 306, and generate a fourth group of locations 508 using at least a portion of the fourth locations 416 associated with the fourth boundary 308(4) of the intersection 306.

In the example of FIG. 5, the aggregation component 120 may additionally remove at least a location 510 associated with the first boundary 308(1) of the intersection 306. For example, the aggregation component 120 may remove the location 510 based on the location 510 being outside of the first group of locations 502, the location 510 being outside of a threshold distance from a selected one of the other first locations 410, and/or using one or more additional and/or alternative processes. Additionally, the aggregation component 120 may remove at least a location 512 associated with the fourth boundary 308(4) of the intersection 306. For example, the aggregation component 120 may remove the location 512 based on the location 512 being outside of the fourth group of locations 508, the location 512 being outside of a threshold distance from a selected one of the other fourth locations 416, and/or using one or more additional and/or alternative processes.

In the example of FIG. 5, the aggregation component 120 may also perform one or more of the processes described herein to generate a group of locations 514 using at least a portion of the locations 418 associated with the first boundary of the feature 310 and generate a group of locations 516 using at least portion of the locations 420 associated with the second boundary of the feature 310.

Referring back to the example of FIG. 1, the mapping component 116 may include an intersection component 122 that is configured to determine final locations and/or final layouts associated with intersections using the projected locations (e.g., the grouped locations). For instance, the mapping component 116 may initially determine a respective final location for one or more (e.g., each) of the boundaries of an intersection. The intersection component 122 may then determine the final location and/or the final layout of the intersection using the final locations of the boundaries. For example, the intersection component 122 may determine the final location and/or the final layout of the intersection by connecting the final locations of the boundaries together. By connecting the final locations for the boundaries together, the intersection component 122 may represent the final location and/or the final layout of the intersection using a bounding shape, such as a polygon.

In some examples, the intersection component 122 may perform one or more additional processes in order to determine final location and/or the final layout of the intersection. For example, the intersection component 122 may extend one or more of the edges of the bounding shape by a given distance. The given distance may include, but is not limited to, 0.1 meters, 0.5 meters, 1 meter, 2 meters, and/or any other distance. By expanding one or more of the edges of the bounding shape, the intersection component 114 may thus ensure that the bounding shape includes an entirety of the intersection.

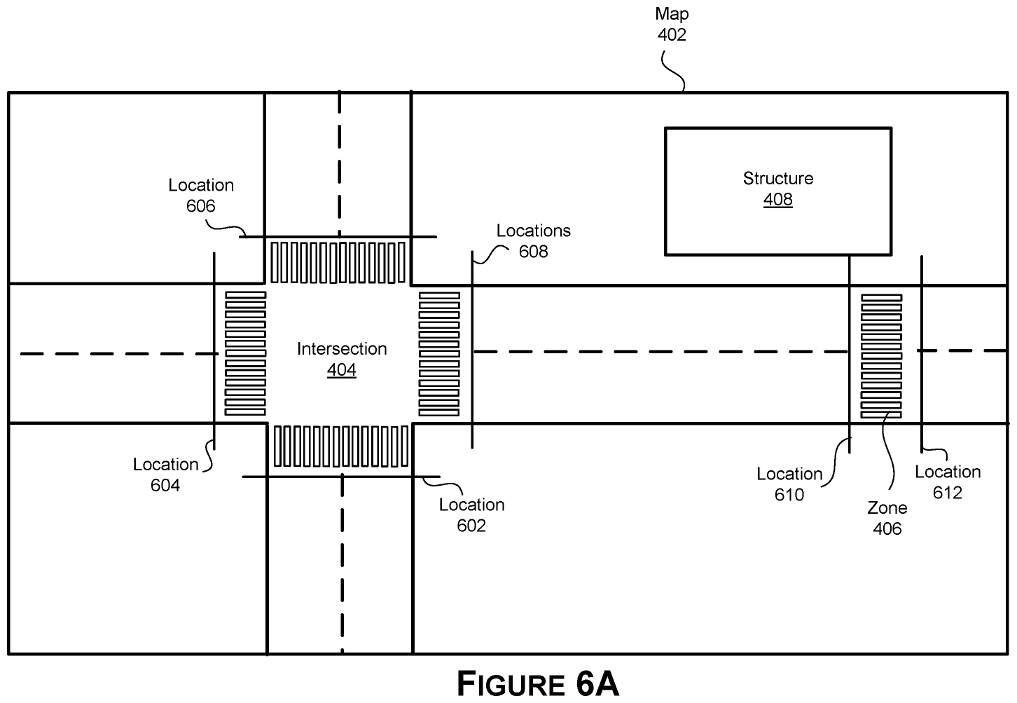

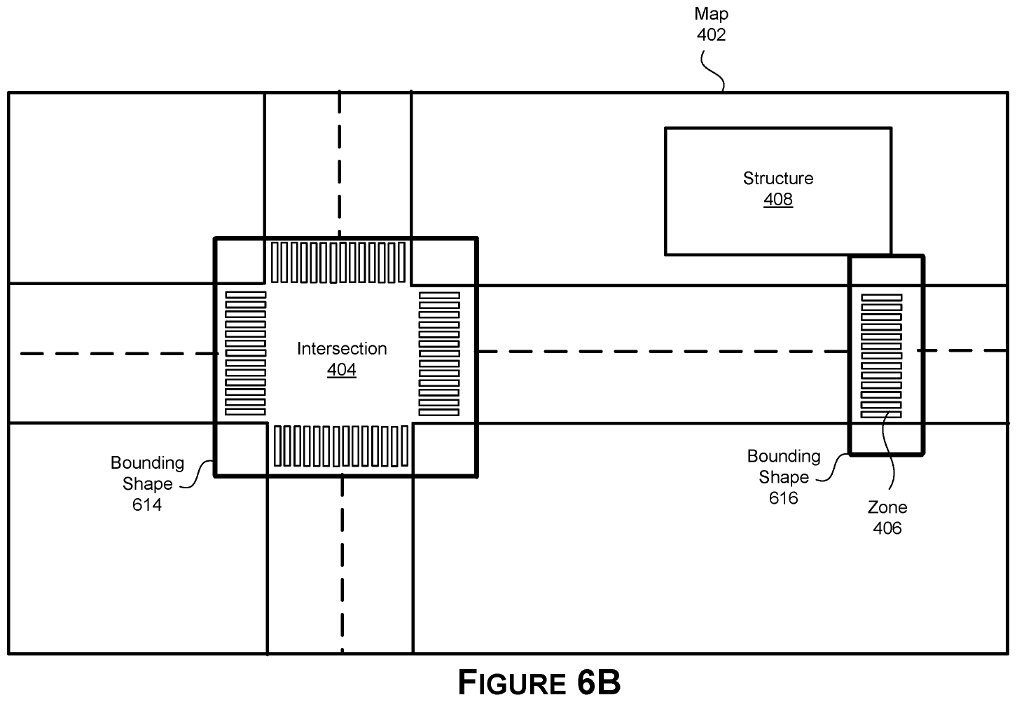

For instance, FIGS. 6A-6B illustrate an example of determining a location and/or a layout of an intersection using locations associated with boundaries of the intersection, in accordance with some embodiments of the present disclosure. As shown by the example of FIG. 6A, the intersection component 122 may initially use the first group of locations 502 to determine a first final location 602 of the first boundary 308(1) associated with the intersection 306, use the second group of locations 504 to determine a second final location 604 of the second boundary 308(2) associated with the intersection 306, use the third group of locations 506 to determine a third final location 606 of the third boundary 308(3) associated with the intersection 306, and use the fourth group of locations 508 to determine a fourth final location 608 of the fourth boundary 308(4) associated with the intersection 306. Additionally, in the example of FIG. 6A, the intersection component 122 may also use the group of locations 514 to determine a final location 610 of the first entrance associated with the feature 310 and use the group of locations 516 to determine a final location 612 of the second entrance associated with the feature 310.

As shown by the example of FIG. 6B, the intersection component 122 may then use the final locations 602, 604, 606, and 608 associated with the intersection 306 to determine a bounding shape 614 that represents the location and/or the layout associated with the intersection 306. While the example of FIG. 6B illustrates the bounding shape 614 as being substantially rectangular, in other examples, the bounding shape 614 may include any other shape. The intersection component 122 may also use the final locations 610 and 612 associated with the feature 310 to determine a bounding shape 616 that represents the location and/or the layout associated with the feature 310. Again, while the example of FIG. 6B illustrates the bounding shape 616 as being substantially rectangular, in other examples, the bounding shape 616 may include any other shape. In some embodiments, additional information associated with the intersection may be associated with the bounding shape (or generally with the intersection), and this information may be encoded into the map data. For example, the information may include classification information (e.g., 3-way stop, traffic light monitored, stop sign monitored, yield, etc.), size information, layout information, speed information, and/or the like. In such example, different information may be encoded for different sides of the bounding shape, such as “right turn only lane” or “cross walk entry.”

Referring back to the example of FIG. 1, the intersection component 122 may further be configured to generate a new map that indicates the locations and/or layouts of intersections (and/or other types of features) and/or update the current map to indicate the locations and/or layouts of the intersections (and/or other types of features). For instance, the intersection component 122 may generate and then output map data 124 representing the new and/or updated map. In some examples, the map data 124 may then be used for one or more additional purposes. For a first example, the map data 124 may be sent to one or more vehicles that then use the map data 124 to identify the locations of intersections (and/or other features) within the environment. For a second example, the map data 124 may be further processed by one or more additional components that are configured to determine features associated with intersections. For instance, the other component(s) may use the bounding shapes of the intersections as indicators of where to further process the map in order to determine features (lane lines, crosswalk lines, street signs, lane directions, etc.) of the intersections.

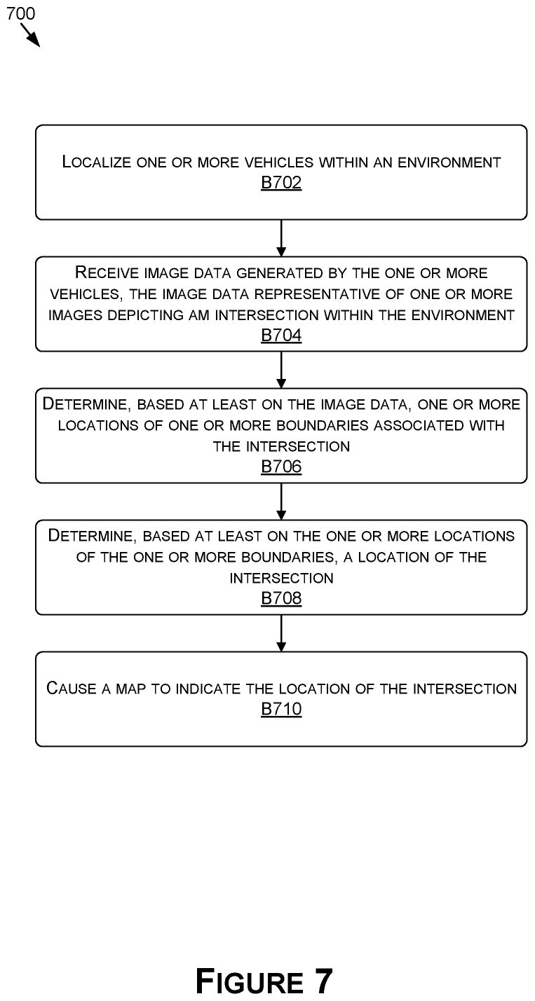

Now referring to FIG. 7, each block of method 700, described herein, comprises a computing process that may be performed using any combination of hardware, firmware, and/or software. For instance, various functions may be carried out by a processor executing instructions stored in memory. The method 700 may also be embodied as computer-usable instructions stored on computer storage media. The method 700 may be provided by a standalone application, a service or hosted service (standalone or in combination with another hosted service), or a plug-in to another product, to name a few. In addition, the method 700 is described, by way of example, with respect to FIG. 1. However, the method 700 may additionally or alternatively be executed by any one system, or any combination of systems, including, but not limited to, those described herein.

FIG. 7 is a flow diagram showing a method 700 for using sensor data to identify an intersection within a map, in accordance with some embodiments of the present disclosure. The method 700, at block B702, may include localizing one or more vehicles within an environment. For instance, a system(s) (e.g., the localization component 102) may receive location data 104 and/or sensor data 106 generated by the one or more vehicles. The system(s) may also receive map data 108 representing the environment for which the one or more vehicles are navigating when generating the location data 104 and/or the sensor data 106. Additionally, the system(s) may use the location data 104, the sensor data 106, and/or the map data 108 to determine one or more locations of the one or more vehicles within the environment. In some examples, the one or more vehicles may be located proximate to an intersection within the environment.

The method 700, at block B704, may include receiving image data generated by the one or more vehicles, the image data representative of one or more images depicting an intersection. For instance, the system(s) (e.g., the perception component 112) may receive the image data (e.g., the sensor data 106) generated by the one or more vehicles. As described herein, the image data may represent the one or more images depicting one or more boundaries of the intersection. For instance, and for a vehicle that navigates through the intersection, the vehicle may generate the image data representing one or more images from a perspective that captures a boundary of the intersection for which the vehicle enters when navigating through the intersection. As such, the one or more images may include multiple images that captured one or more (e.g., each) of the boundaries of the intersection.

The method 700, at block B706, may include determining, based at least on the image data, one or more locations of one or more boundaries associated with the intersection. For instance, the system(s) (e.g., the perception component 112) may process the image data in order to determine the one or more locations associated with the one or more boundaries. For example, and for an image, the system(s) may process the image data representing the image to determine a bounding shape that indicates the location of the intersection as depicted by the image. The system(s) may then use the bounding shape to determine a location of a boundary associated with the intersection. For instance, the system(s) may determine that the location of the boundary corresponds to a portion of the bounding shape, such as the bottom edge of the bounding shape, within the image.

The method 700, at block B708, may include determining, based at least on the one or more locations of the one or more boundaries, a location of the intersection. For instance, the system(s) (e.g., the mapping component 116) may use the one or more locations to determine the location and/or the layout of the intersection. In some examples, to determine the location of the intersection, the system(s) may group one or more of the locations for the one or more boundaries and/or filter out one or more of the locations for the one or more boundaries. The system(s) may then use the groups to determine one or more final locations associated with the one or more boundaries. Additionally, the system(s) may use the one or more final locations to determine a bounding shape that represents the location and/or the layout of the intersection.

The method 700, at block B710, may include causing a map to indicate the location of the intersection. For instance, the system(s) (e.g., the mapping component 116) may cause the map to indicate the location of the intersection. In some examples, the system(s) may generate a new map that includes the bounding shape indicating the location and/or the layout of the intersection. In some examples, the system(s) may update a map to include the bounding shape indicating the location and/or the layout of the intersection.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an ×86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving image data generated using one or more sensors of a vehicle, the sensor data representative of an image depicting at least a portion of an intersection;
determining, based at least on the sensor data, a boundary location of a boundary associated with the intersection;
determining, based at least on the boundary location, an intersection location associated with the intersection; and
updating a map to indicate the intersection location.

2. The method of claim 1, further comprising:
receiving second sensor data generated using the one or more sensors of the vehicle, the second sensor data representative of a second image depicting at least a second portion of the intersection;
determining, based at least on the second sensor data, a second boundary location of the boundary associated with the intersection; and
determining, based at least on the boundary location and the second boundary location, a third boundary location of the boundary associated with the intersection,
wherein the determining the intersection location associated with the intersection is based at least on the third boundary location.

3. The method of claim 1, wherein the determining the boundary location of the boundary comprises:
determining, based at least on the sensor data, a bounding shape indicating an area of the image that depicts the intersection; and
determining, based at least on the bounding shape, the boundary location of the boundary associated with the intersection.

4. The method of claim 1, further comprising:
receiving second sensor data generated using the one or more sensors of the vehicle or one or more second sensors of a second vehicle, the second sensor data representative of a second image depicting at least a second portion of the intersection; and
determining, based at least on the second sensor data, a second boundary location of a second boundary associated with the intersection,
wherein the determining the intersection location associated with the intersection is further based at least on the second boundary location of the second boundary.

5. The method of claim 1, further comprising:
receiving second sensor data generated using one or more second sensors of one or more second vehicles, the second sensor data representative of one or more second images depicting at least a second portion of the intersection;
determining, based at least the second sensor data, one or more second boundary locations of one or more second boundaries associated with the intersection; and
determining, based at least on the boundary location and the one or more second boundary locations, a bounding shape indicating the intersection location associated with the intersection,
wherein the updating the map includes storing data corresponding to the bounding shape in map data corresponding to the map.

6. The method of claim 1, further comprising:
receiving second sensor data generated using at least one of the vehicle or one or more second vehicles, the second sensor data representative of one or more second images depicting at least a second portion of the intersection;
determining, based at least the second sensor data, one or more second boundary locations of the boundary associated with the intersection;
determining a filtered set of boundary locations of the boundary by removing at least one of the boundary location or at least one of the one or more second boundary locations; and
determining, based at least on the filtered set of boundary locations of the boundary, a final boundary location of the boundary associated with the intersection,
wherein the determining the intersection location is based at least on the final boundary location of the boundary.

7. The method of claim 6, wherein the determining the final boundary comprises determining the final boundary location as an average location of the filtered set of boundary locations.

8. The method of claim 1, further comprising:
receiving second sensor data generated using the vehicle, at least a portion of the second sensor data being generated using the vehicle while the vehicle generated the sensor data; and
localizing, based at least on at least one of the first sensor data or the second sensor data, the vehicle with respect to the map,
wherein the determining the intersection location is further based at least on the localizing.

9. A system comprising:
one or more processing units to:
determine a vehicle location of a vehicle within an environment;
receive image data generated using the vehicle, the image data representative of an image depicting an intersection within the environment;
determine, based at least on the image data, a location of the intersection within the environment; and
based at least on the vehicle location and the location of the intersection, causing a map to indicate the location of the intersection.

10. The system of claim 9, wherein the determination of the location of the intersection within the environment comprises:
determining, based at least on the image data, a boundary location of a boundary associated with the intersection; and
determining, based at least on the boundary location, the location of the intersection within the environment.

11. The system of claim 10, wherein the determination of the boundary location comprises:
determining, based at least on the image data, a bounding shape indicating an area of the image that depicts the intersection; and
determining, based at least on the bounding shape, the boundary location.

12. The system of claim 10, wherein the one or more processing units are further to:
receive second image data generated using the vehicle or a second vehicle, the second image data representative of a second image depicting the intersection; and
determine, based at least on the second image data, a second boundary location of a second boundary associated with the intersection; and
wherein the determination of the location of the intersection is further based at least on the second boundary location.

13. The system of claim 9, wherein the one or more processing units are further to:
receive second image data generated using the vehicle or one or more second vehicles, the second image data representative of one or more second images depicting the intersection; and
determine, based at least on the image data and the second image data, one or more boundary locations of one or more boundaries associated with the intersection,
wherein:
the determination of the location of the intersection within the environment comprises determining, based at least on the one or more boundary locations, a bounding shape indicating the location of the intersection within the environment; and
the map is caused to indicate the location of the intersection based at least on the bounding shape.

14. The system of claim 9, wherein the one or more processing units are further to:
receive second image data generated using the vehicle or one or more second vehicles, the second image data representative of one or more second images depicting the intersection;
determine, based at least on the image data and the second image data, one or more second locations of the intersection within the environment; and
determine a filtered set of locations of the intersection, at least, by removing at least one of the one or more second locations,
wherein the determination of the location of the intersection within the environment is based at least on the filtered set of locations.

15. The system of claim 14, wherein the location of the intersection within the environment is determined, at least, by determining the location of the intersection within the environment as an average location of the filtered set of locations.

16. The system of claim 9, wherein:
the determination of the location of the vehicle within the environment is with respect to the map; and
the map to is caused to indicate the location of the intersection, at least, by updating the map to indicate the location of the intersection.

17. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to update a map to indicate one or more locations of one or more boundaries associated with an intersection, wherein the map is updated based at least on determining the one or more locations of the one or more boundaries using image data generated using a plurality of vehicles.

19. The processor of claim 18, wherein the map is updated further based at least on localizing the plurality of vehicles with respect to the map.

20. The processor of claim 18, wherein the process is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
